(19) United States
(12) Patent Application Publication
(10) Pub. No.: US 2015/0049600 A1
(43) Pub. Date: Feb. 19, 2015

(54) PRIORITIZING FREQUENCIES IN EMBMS MULTI-FREQUENCY DEPLOYMENT DURING RLF/OOS

(71) Applicant: QUALCOMM Incorporated, San Diego, CA (US)

(72) Inventors: Arun Prasanth BALASUBRAMANIAN, Hyderabad (IN); Muralidharan MURUGAN, San Diego, CA (US); Daniel AMERGA, San Diego, CA (US)

(73) Assignee: QUALCOMM Incorporated, San Diego, CA (US)

(21) Appl. No.: 14/154,095

(22) Filed: Jan. 13, 2014

Related U.S. Application Data
(60) Provisional application No. 61/866,405, filed on Aug. 15, 2013.

(51) Int. Cl. H04W 76/02; H04W 24/04; H04W 76/00; H04W 48/16

(52) U.S. Cl. CPC H04W 76/028; H04W 48/16; H04W 24/04; H04W 76/002
USPC 370/216

(57) ABSTRACT

A method, an apparatus, and a computer program product for wireless communication are provided. The apparatus may be a UE. The UE receives, from a serving cell, system information including a plurality of SAIs. The UE determines an interest in receiving an MBMS service from at least one cell on one or more candidate frequencies based on the received SAIs. The UE determines that the UE has encountered one of an RLF or an OOS on the serving cell. The UE prioritizes network reestablishment on the one or more frequencies that carry the MBMS service the UE is interested in receiving upon determining the UE encountered the one of the RLF or the OOS.

### CROSS-REFERENCE TO RELATED APPLICATION(S)

This application claims the benefit of U.S. Provisional Application Ser. No. 61/866,405, entitled “PRIORITIZING FREQUENCIES IN EMBMS MULTI-FREQUENCY DEPLOYMENT DURING RLF/OOS” and filed on Aug. 15, 2013, which is expressly incorporated by reference herein in its entirety.

### BACKGROUND

1. Field

The present disclosure relates generally to communication systems, and more particularly, to prioritizing frequencies in evolved Multimedia Broadcast Multicast Service (MBMS) (eMBMS) multi-frequency deployment during radio link failure (RLF) or out of service (OOS).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be a UE. The UE receives, from a serving cell, system information including a plurality of service area identities (SAIs). The UE determines an interest in receiving an MBMS service from at least one cell on one or more candidate frequencies based on the received SAIs. The UE determines that the UE has encountered one of an RLF or an OOS on the serving cell. The UE prioritizes network reestablishment on the one or more frequencies that carry the MBMS service the UE is interested in receiving upon determining the UE encountered the one of the RLF or the OOS.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information Media Access Control control element.

FIG. 8 is a diagram illustrating a first method of prioritizing network reestablishment.

FIG. 9 is a diagram illustrating a call flow of a second method of prioritizing network reestablishment.

FIG. 10 is a diagram illustrating a call flow of a third method of prioritizing network reestablishment.

FIG. 11 is a diagram illustrating a call flow of a fourth method of prioritizing network reestablishment.

FIG. 12 is a flow chart of a first method of wireless communication.

FIG. 13 is a flow chart of a second method of wireless communication.

FIG. 14 is a flow chart of a third method of wireless communication.

FIG. 15 is a flow chart of a fourth method of wireless communication.

FIG. 16 is a conceptual data flow diagram illustrating the data flow between different modules/means/components in an exemplary apparatus.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

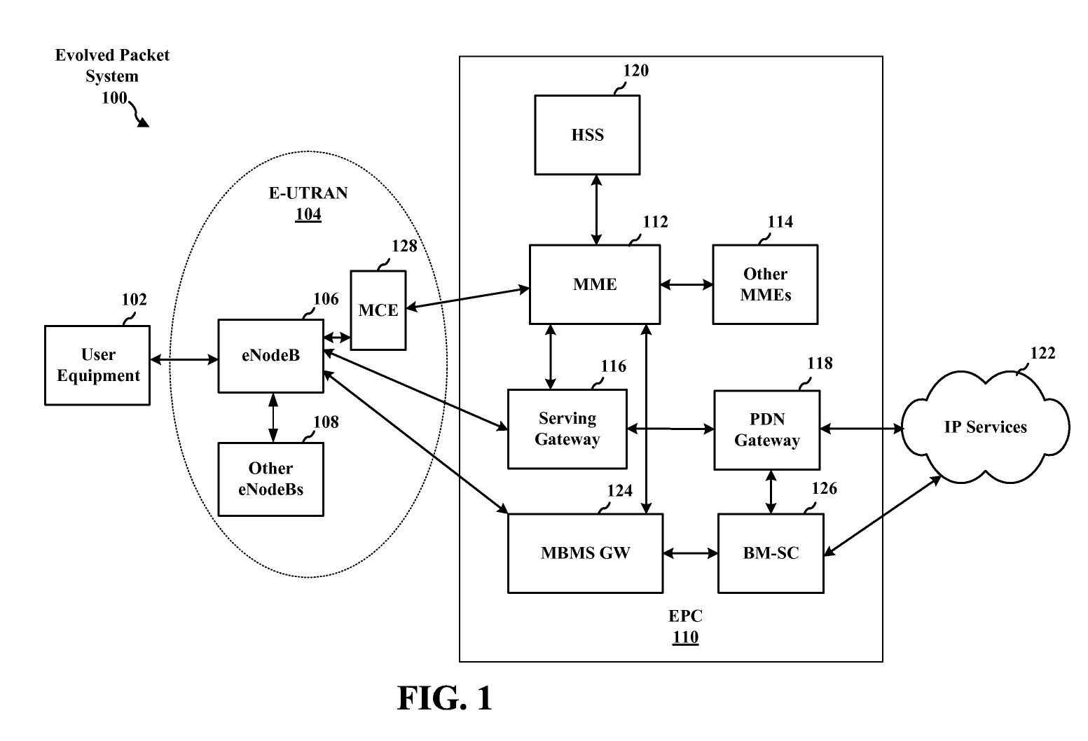

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for eMBMS, and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

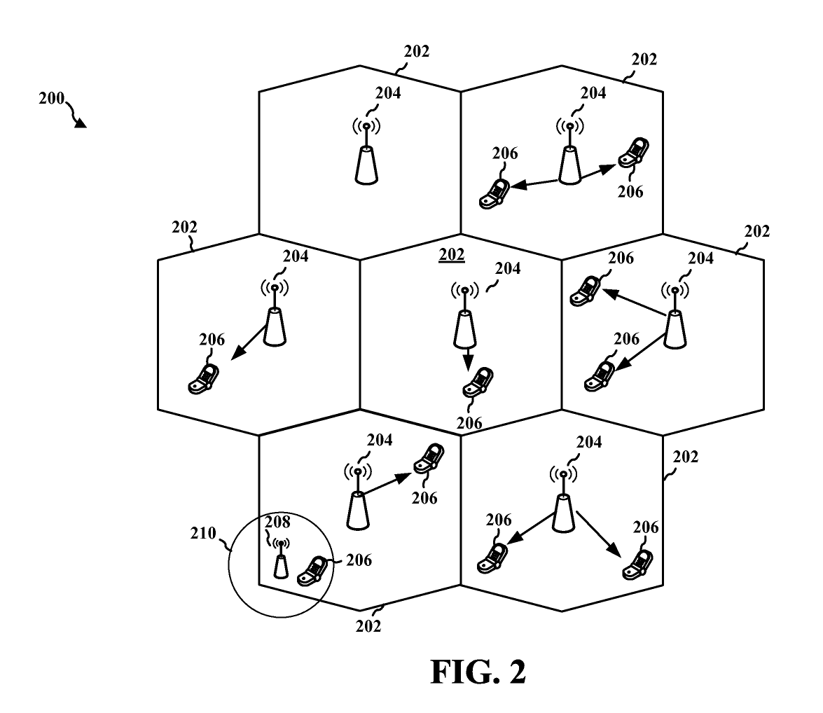

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein depending on the context.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

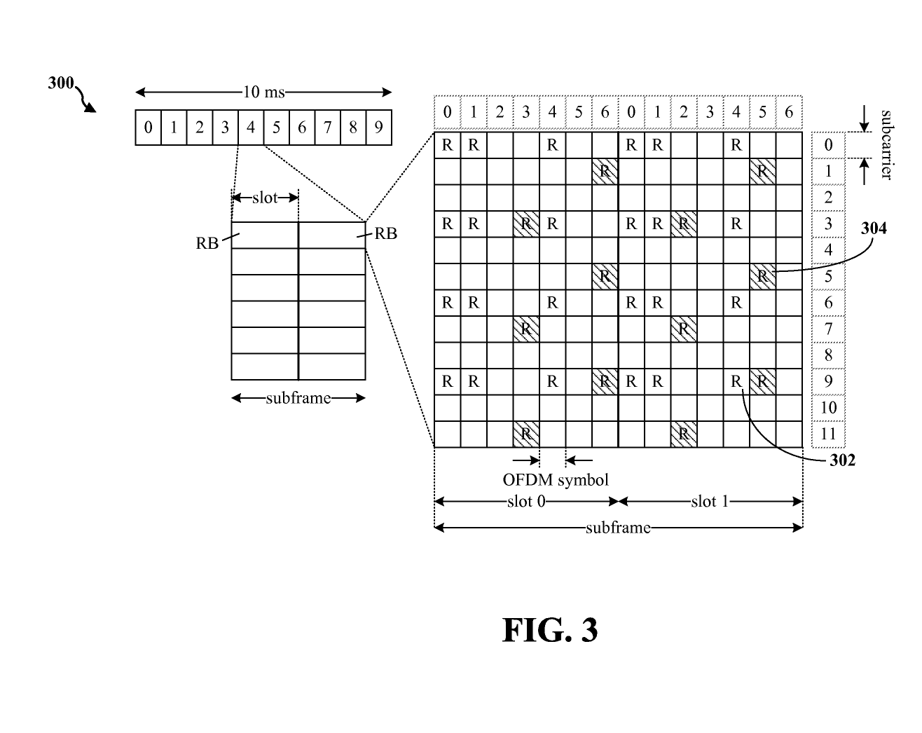

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block may contain 12 consecutive subcarriers in the frequency domain and, for a normal cyclic prefix in each OFDM symbol, 7 consecutive OFDM symbols in the time domain, or 84 resource elements. For an extended cyclic prefix, a resource block may contain 6 consecutive OFDM symbols in the time domain, or 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

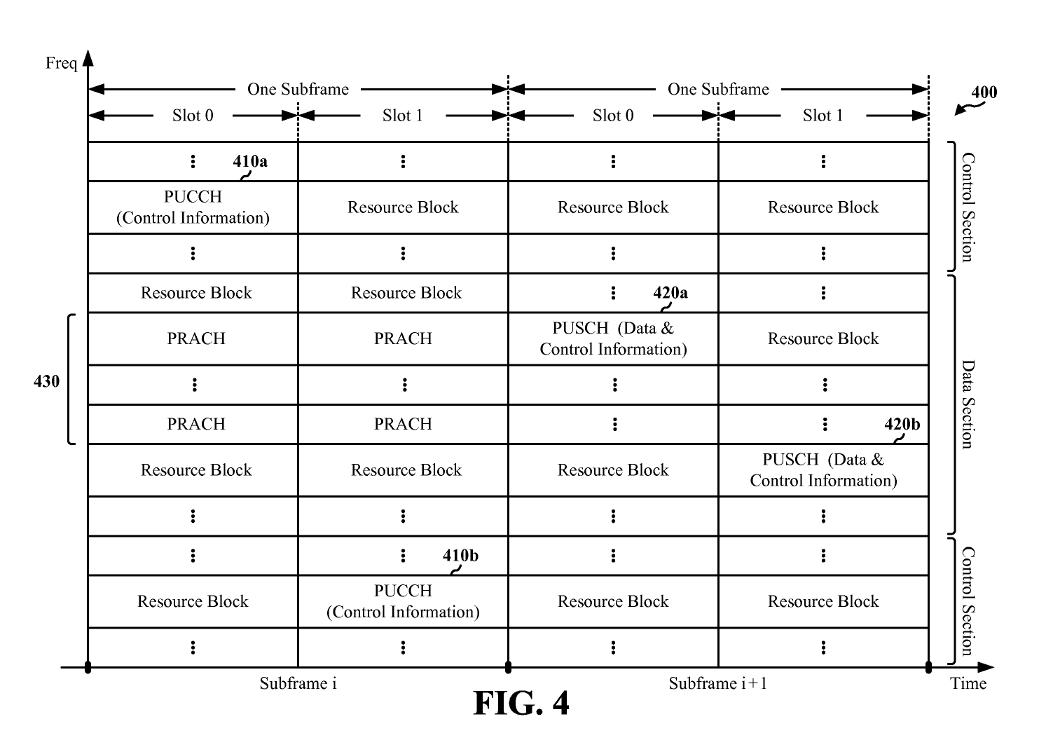

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (RACH) (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

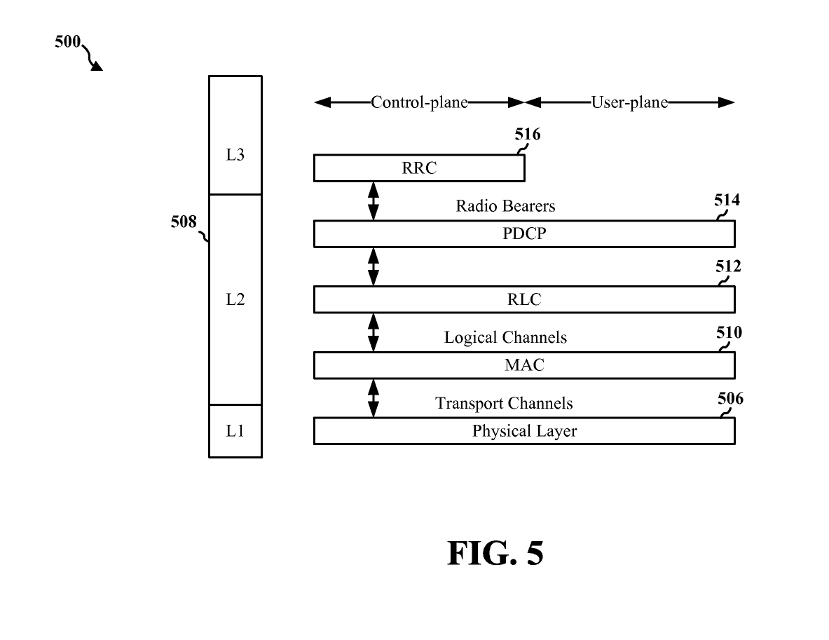

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

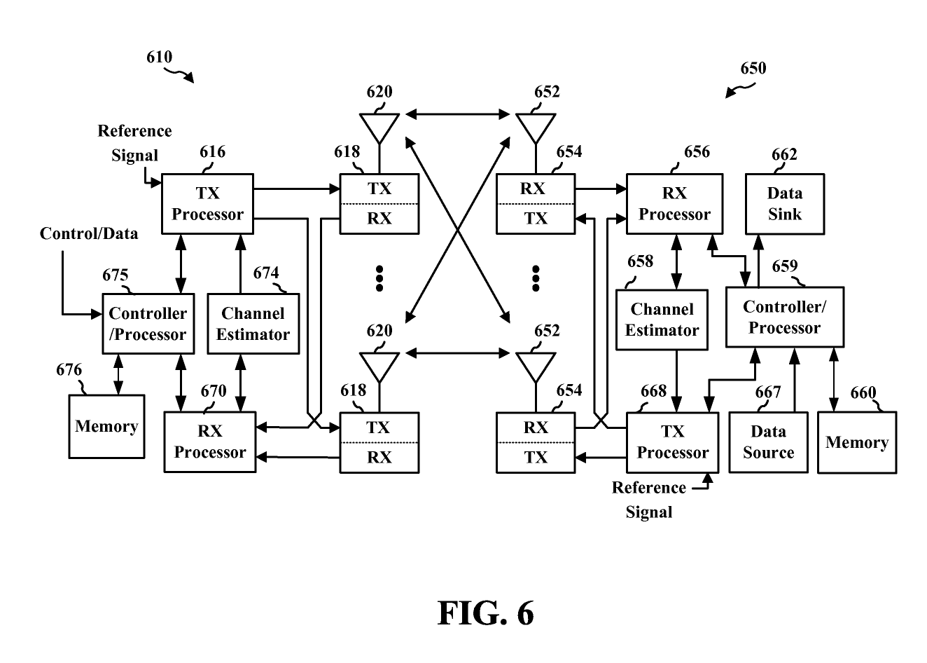

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each sub carrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

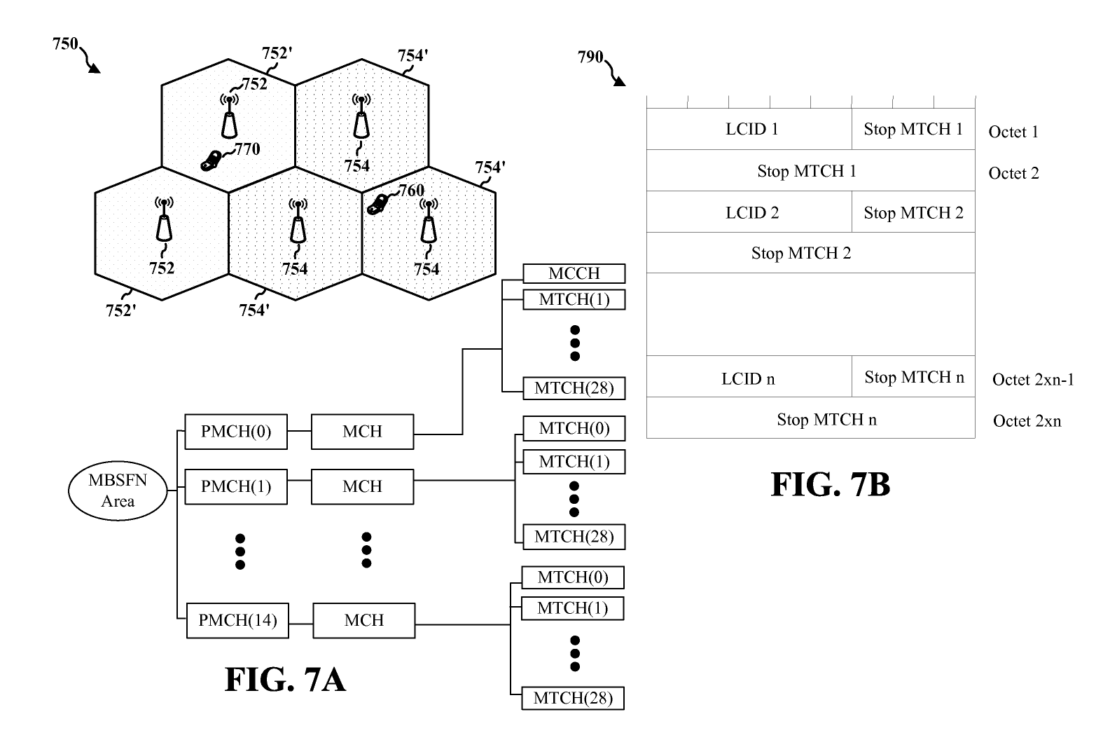

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE may acquire a system information block (SIB) 13 (SIB13). In a second step, based on the SIB13, the UE may acquire an MBSFN Area Configuration message on an MCCH. In a third step, based on the MBSFN Area Configuration message, the UE may acquire an MCH scheduling information (MSI) MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may include (1) a temporary mobile group identity (TMGI) and an optional session identifier of each MTCH identified by a logical channel identifier within the PMCH, (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

A UE may receive a user service description (USD) indicating available MBMS services and the TMGIs and SAIs associated with the available MBMS services. An eNB may broadcast a SIB 15 (SIB15) to indicate the SAIs that are available at the current frequency (the frequency on which the SIB15 was broadcasted) and at neighboring frequencies. Accordingly, based on the received USD and SIB15, a UE may be able to determine MBMS services that the UE can receive from the eNB. When a UE is interested in an MBMS service available on one of the frequencies associated with the indicated SAIs, the UE may send an MBMS interest indication message to indicate such interest to a serving eNB. The serving eNB may then hand over the UE to another eNB on the frequency of interest. Further, if the UE is receiving an MBMS service at the current frequency, the UE may send an MBMS interest indication message indicating an interest in receiving the current frequency so that the network does not configure parameters that affect service reception. A UE may maintain a list of the last N (e.g., 10) camped frequencies. Whenever an RLF occurs, a UE initially tries to reestablish a connection on the last N camped frequencies. Subsequently, if unable to reestablish a connection on one of the last N camped frequencies, the UE may scan for more frequencies (e.g., 50) in each and every supported band until the UE finds a suitable frequency to reestablish a connection. There is currently a need for methods and apparatuses for prioritizing frequencies in eMBMS multi-frequency deployment when a UE encounters an RLF/OOS.

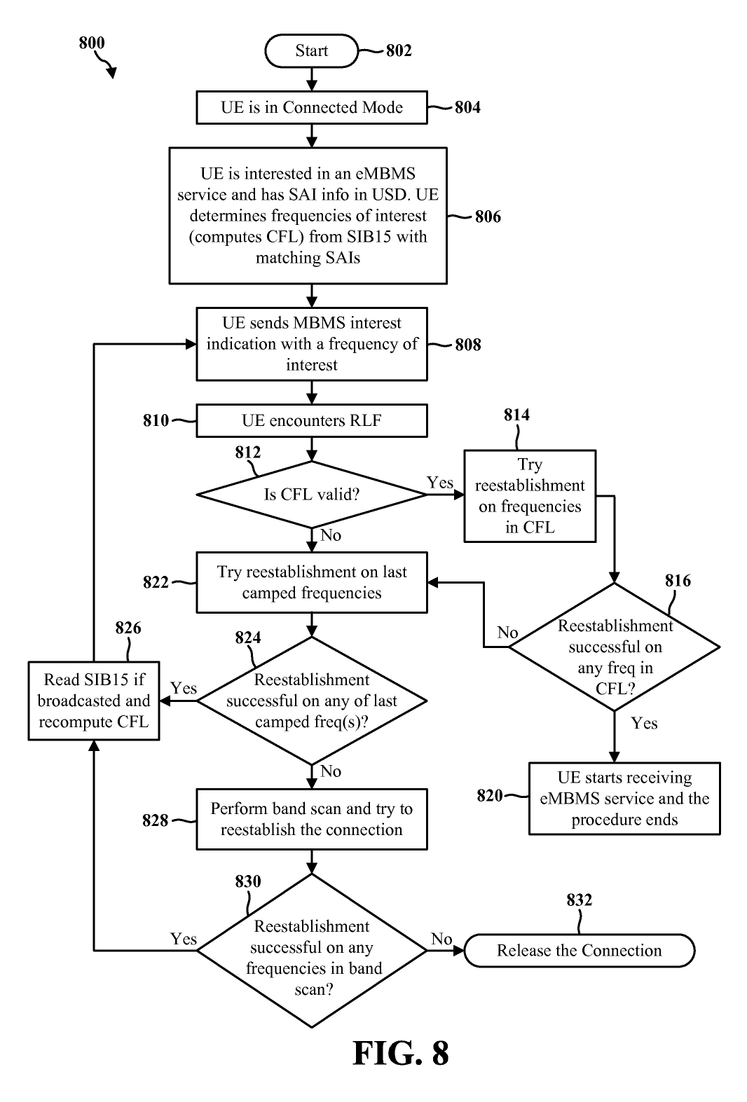

FIG. 8 is a flow chart 800 illustrating a first method of prioritizing network reestablishment. The first exemplary method is a method of RLF handling in an eMBMS multi-frequency scenario. The method is performed by a UE. The method starts at step 802. At step 804, the UE is in an RRC connected state/mode. At step 806, the UE is interested in an eMBMS service with a particular TMGI and has received a USD including TMGIs and associated SAIs. The UE computes (or determines, generates, or constructs) a candidate frequency list (CFL) including frequencies of interest from the SIB15 with matching SAIs. Specifically, in step 806, the UE determines available SAIs from the SIB15. In addition, the UE determines the eMBMS service of interest in the USD that is associated with the particular TMGI on one of the available SAIs. The UE then adds the frequency on which the eMBMS service of interest can be obtained to the CFL. At step 808, the UE may send an MBMS interest indication message indicating a frequency of interest. At step 810, the UE encounters an RLF. If in step 812, the CFL is valid (the UE previously computed a CFL and/or the CFL was generated within a threshold time period), in step 814, the UE tries to reestablish a connection on a frequency in the CFL. In step 814, the UE reestablishes a connection with a cell on a frequency in the CFL by performing a RACH procedure with the cell. In the RACH procedure, the UE sends a random access preamble to the cell, the UE receives in response a random access response from the cell, the UE sends the cell an RRC connection reestablishment request, and the UE receives in response RRC connection reestablishment message from the cell. At step 814, by trying to reestablish a connection on a frequency in the CFL before trying to reestablish a connection on any of the last camped frequencies (see step 822), the UE prioritizes network reestablishment on one or more frequencies in the CFL that carry the MBMS service the UE is interested in receiving. If at step 816, the reestablishment is successful on any frequency in the CFL, in step 820, the UE starts receiving an eMBMS service of interest on the frequency. Otherwise, if in step 816 the reestablishment is unsuccessful on any frequency in the CFL or the CFL is invalid in step 812, in step 822, the UE tries to reestablish a connection on one of the last N camped frequencies. If in step 824, the reestablishment is successful on any of the last N camped frequencies, in step 826, the UE obtains the SIB15 if broadcasted, recomputes the CFL, and returns to step 808. Otherwise, if in step 824, the reestablishment is unsuccessful on the last N camped frequencies, in step 828, the UE performs a band scan and tries to reestablish a connection. If in step 830, the reestablishment is unsuccessful on frequencies in the band scan, in step 832, the UE releases the connection. Otherwise, if in step 830, the reestablishment is successful on any of the frequencies in the band scan, in step 826, the UE obtains the SIB15 if broadcasted, recomputes the CFL, and returns to step 808.

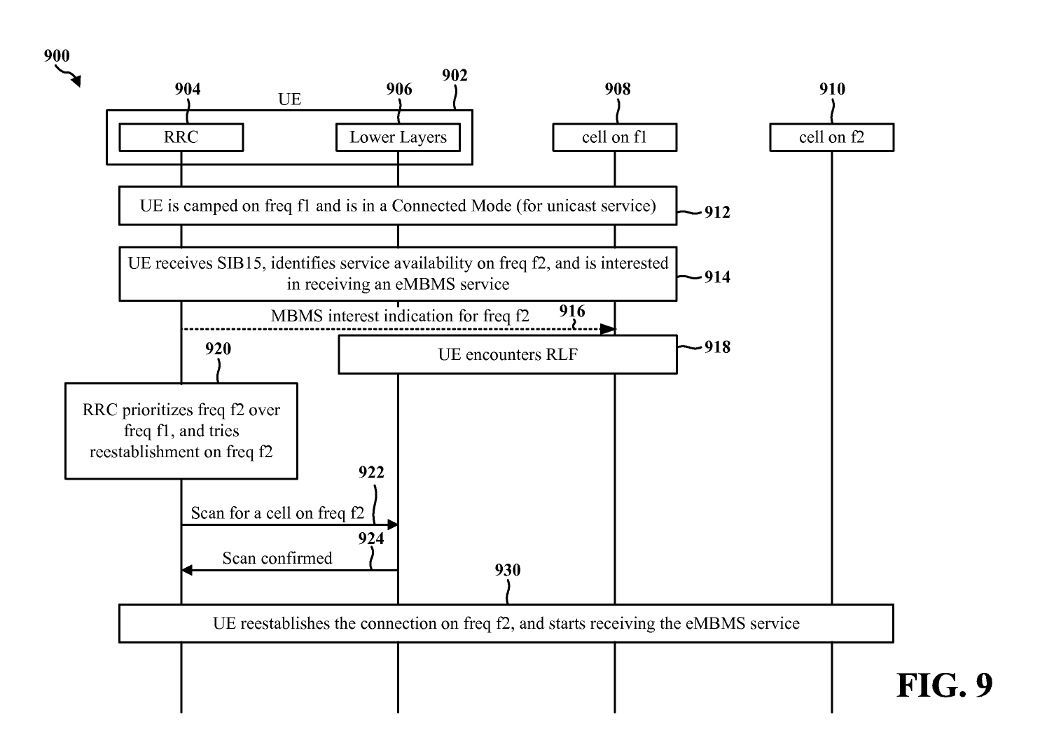

FIG. 9 is a diagram 900 illustrating a call flow of a second method of prioritizing network reestablishment. As shown in FIG. 9, at step 912, a UE 902 is camped on a first frequency f₁, is in an RRC connected mode with a serving cell 908 on f₁, and is receiving a unicast service from the cell 908. At step 914, the UE 902 receives a SIB15 from the cell 908. The SIB15 includes SAIs that are available at the current frequency f₁ and at neighboring frequencies, including the frequency f₂ for the cell 910. The neighboring frequencies, including the frequency f₂, are provided by the cell 910 and other cells. The cell 908 and the cell 910 may be provided by the same eNB or by different eNBs. For example, the frequencies f₁ and f₂ may be provided by a serving eNB. For another example, the frequency f₁ may be provided by a serving eNB and the frequency f₂ may be provided by a neighboring eNB. Based on the received SAIs in the SIB 15, the UE 902 determines service availability on the frequency f₂ from the cell 910. Based on a received USD, the UE determines an interest in receiving an MBMS service associated with an SAI for the frequency f₂. At step 916, the UE 902 may send an MBMS interest indication message to the cell 908 indicating an interest in receiving an MBMS service on the frequency f₂. The step 916 may correspond to the step 808 of FIG. 8. At step 918, the UE encounters an RLF. At step 920, if the CFL is valid (see step 812), the UE 902 prioritizes the frequency f₂ over the frequency f₁ and then initiates the process for reestablishing the RRC connection on the frequency f₂. Step 920 may correspond to steps 806 and 814 of FIG. 8. At step 922, the UE 902 scans for a cell on the frequency f₂. The RRC layer 904 of the UE 902 may request lower layers 906 to scan for a cell on the frequency f₂. When scanning for a cell on the frequency f₂, the UE 902 may receive pilot signals from the cell on the frequency f₂ and determine whether the signal quality of the pilot signals from the cell on the frequency f₂ is greater than a threshold. If the signal quality is greater than the threshold, the UE 902 may camp on the cell on the frequency f₂. If the signal quality is less than the threshold, the UE 902 may determine not to camp on the cell on the frequency f₂. At step 924, the RRC layer 904 of the UE 902 may receive a confirmation that the scan was successful from the lower layers 906 of the UE 902, and the UE 902 may then determine that the UE 902 may camp on the cell on the frequency f₂. At step 930, the UE 902 camps on the cell on the frequency f₂, reestablishes the RRC connection on the cell on the frequency f₂, and starts receiving the eMBMS service of interest from the cell on the frequency f₂.

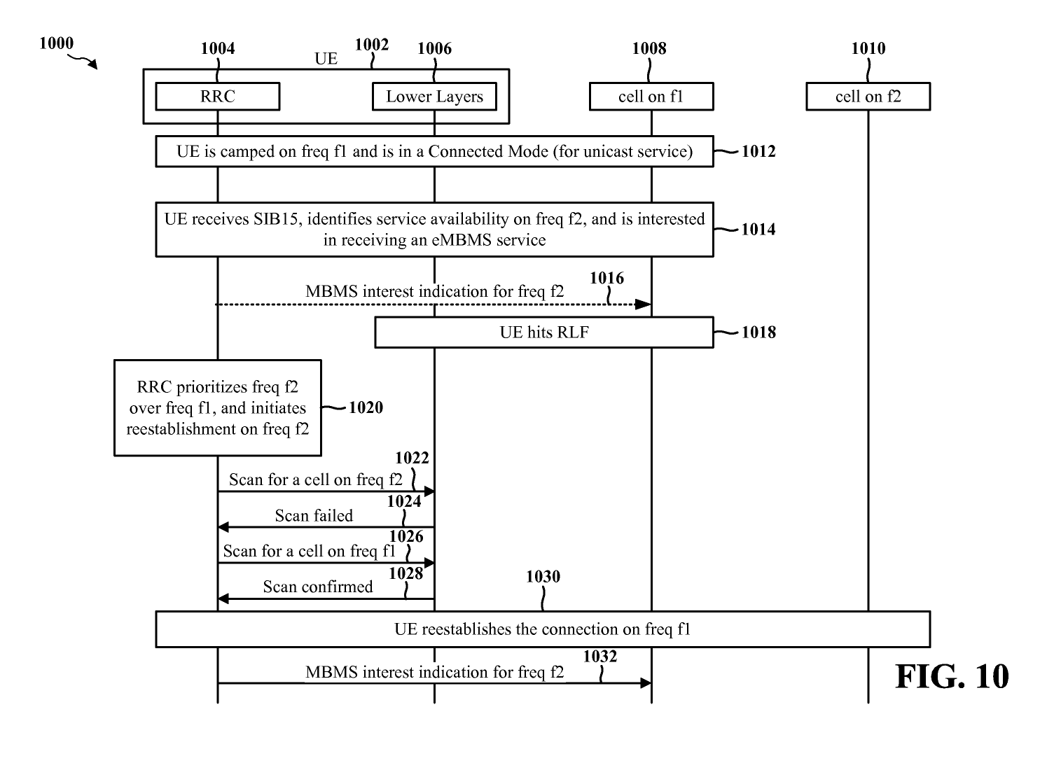

FIG. 10 is a diagram 1000 illustrating a call flow of a third method of prioritizing network reestablishment. As shown in FIG. 10, at step 1012, a UE 1002 is camped on a first frequency f₁, is in an RRC connected mode with a serving cell 1008 on and is receiving a unicast service from the cell 1008. At step 1014, the UE 1002 receives a SIB15 from the cell 1008. The SIB15 includes SAIs that are available at the current frequency f₁ and at neighboring frequencies, including the frequency f₂ for the cell 1010. The neighboring frequencies, including the frequency f₂, are provided by the cell 1010 and other cells. The cell 1008 and the cell 1010 may be provided by the same eNB or by different eNBs. For example, the frequencies f₁ and f₂ may be provided by a serving eNB. For another example, the frequency f₁ may be provided by a serving eNB and the frequency f₂ may be provided by a neighboring eNB. Based on the received SAIs in the SIB15, the UE 1002 determines service availability on the frequency f₂ from the cell 1010. Based on a received USD, the UE determines an interest in receiving an MBMS service associated with an SAI for the frequency f₂. At step 1016, the UE 1002 may send an MBMS interest indication message to the cell 1008 indicating an interest in receiving an MBMS service on the frequency f₂. The step 1016 may correspond to the step 808 of FIG. 8. At step 1018, the UE encounters an RLF. At step 1020, if the CFL is valid (see step 812), the UE 1002 prioritizes the frequency f₂ over the frequency f₁ and then initiates the process for reestablishing the RRC connection on the frequency f₂. Step 1020 may correspond to steps 806 and 814 of FIG. 8. If the CFL is not valid, see steps 822-832. At step 1022, the UE 1002 scans for a cell on the frequency f₂. The RRC layer 1004 of the UE 1002 may request lower layers 1006 to scan for a cell on the frequency f₂. When scanning for a cell on the frequency f₂, the UE 1002 may receive pilot signals from the cell on the frequency f₂ and determine whether the signal quality of the pilot signals from the cell on the frequency f₂ is greater than a threshold. If the signal quality is greater than the threshold, the UE 1002 may camp on the cell on the frequency f₂. If the signal quality is less than the threshold, the UE 1002 may determine not to camp on the cell on the frequency f₂. At step 1024, the RRC layer 1004 of the UE 1002 may receive an indication that the scan was unsuccessful from the lower layers 1006 of the UE 1002, and the UE 1002 may then determine that the UE 1002 may not camp on the cell on the frequency f₂. At step 1026, the UE 1002 scans for a cell on the frequency f₁. At step 1028, the RRC layer 1004 of the UE 1002 may receive a confirmation that the scan was successful from the lower layers 1006 of the UE 1002, and the UE 1002 may then determine that the UE 1002 may camp on the cell on the frequency f₁. At step 1030, the UE 1002 camps on the cell on the frequency f₁ and reestablishes the RRC connection on the cell on the frequency f₁. In step 1032, the UE 1002 sends an MBMS interest indication message to the cell 1008 indicating an interest in receiving an MBMS service on the frequency f₂. The cell 1008 may then determine to hand over the UE 1002 to the cell 1010 on the frequency f₂ so that the UE may receive an eMBMS service on the frequency f₂.

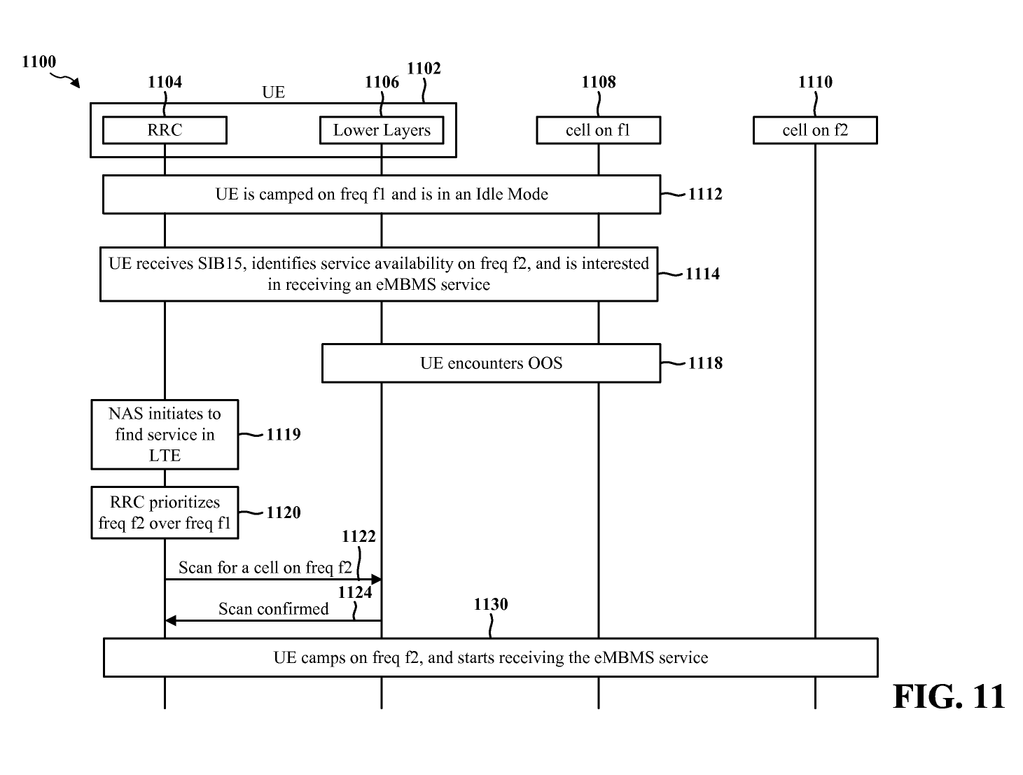

FIG. 11 is a diagram 1100 illustrating a call flow of a fourth method of prioritizing network reestablishment. In the fourth method, a UE prioritizes frequencies during cell selection in an idle mode. As shown in FIG. 11, at step 1112, a UE 1102 is camped on a first frequency f₁, is in an RRC idle mode with a serving cell 1108 on f₁, and is interested in receiving an eMBMS service from the cell 1108. At step 1114, the UE 1102 receives a SIB15 from the cell 1108. The SIB15 includes SAIs that are available at the current frequency f₁ and at neighboring frequencies, including the frequency f₂ for the cell 1110. The neighboring frequencies, including the frequency f₂, are provided by the cell 1110 and other cells. The cell 1108 and the cell 1110 may be provided by the same eNB or by different eNBs. For example, the frequencies f₁ and f₂ may be provided by a serving eNB. For another example, the frequency f₁ may be provided by a serving eNB and the frequency f₂ may be provided by a neighboring eNB. Based on the received SAIs in the SIB15, the UE 1102 determines service availability on the frequency f₂ from the cell 1110. Based on a received USD, the UE determines an interest in receiving an MBMS service associated with an SAI for the frequency f₂. At step 1118, the UE encounters an OOS. At step 1119, the non-access stratum (NAS) layer of the UE may initiate to find a service in LTE if the RRC goes OOS with the current serving cell. At step 1120, if the CFL is valid (see step 812), the UE 1102 prioritizes the frequency f₂ over the frequency f₁ and then initiates the process for scanning for cells on the frequency f₂. Step 1120 may correspond to steps 806 and 814 of FIG. 8. If the CFL is not valid, see steps 822-832. At step 1122, the UE 1102 scans for a cell on the frequency f₂. The RRC layer 1104 of the UE 1102 may request lower layers 1106 to scan for a cell on the frequency f₂. When scanning for a cell on the frequency f₂, the UE 1102 may receive pilot signals from the cell on the frequency f₂ and determine whether the signal quality of the pilot signals from the cell on the frequency f₂ is greater than a threshold. If the signal quality is greater than the threshold, the UE 1102 may camp on the cell on the frequency f₂. If the signal quality is less than the threshold, the UE 1102 may determine not to camp on the cell on the frequency f₂. At step 1124, the RRC layer 1104 of the UE 1102 may receive a confirmation that the scan was successful from the lower layers 1106 of the UE 1102, and the UE 1102 may then determine that the UE 1102 may camp on the cell on the frequency f₂. At step 1130, the UE 1102 camps on the cell on the frequency f₂ and starts receiving the eMBMS service of interest from the cell on the frequency f₂.

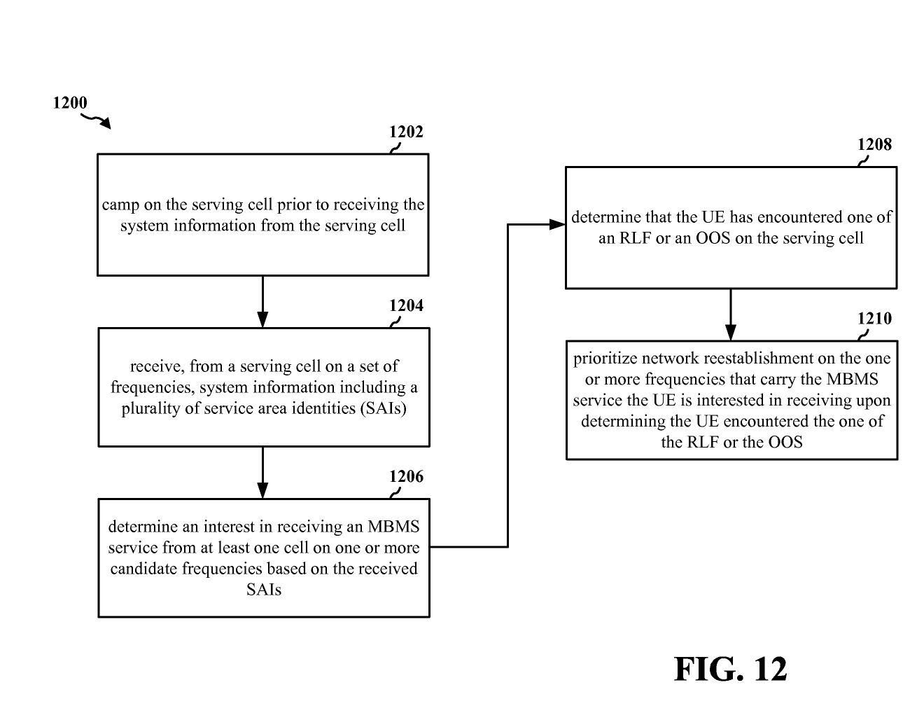

FIG. 12 is a flow chart 1200 of a first method of wireless communication. The method may be performed by a UE. In step 1202, the UE camps on the serving cell prior to receiving the system information from the serving cell. To camp on the serving cell, the UE scans to find the serving cell, obtains the primary synchronization signal (PSS) and secondary synchronization signal (SSS) from the serving cell, and decodes the physical broadcast channel (PBCH) to obtain the MIB and SIBs. The system information may be received in a SIB15. In step 1204, the UE receives, from a serving cell, system information including a plurality of SAIs. In step 1206, the UE determines an interest in receiving an MBMS service from at least one cell on one or more candidate frequencies based on the received SAIs. As discussed supra, the UE may determine available SAIs from the received SIB15. From the USD, the UE may determine available MBMS services corresponding to the available SAIs. The UE may then determine an interest in receiving one of the available MBMS services. In step 1208, the UE determines that the UE has encountered one of an RLF or an OOS on the serving cell. In step 1210, the UE prioritizes network reestablishment on one or more frequencies that carry the MBMS service the UE is interested in receiving upon determining the UE encountered the one of the RLF or the OOS. As discussed supra, the UE may prioritize network reestablishment on one or more frequencies by computing a CFL and attempting to camp on one or more frequencies in the CFL before attempting to camp on any of the last camped frequencies. Further, the UE may prioritize network reestablishment on one or more frequencies by attempting to reestablish an RRC connection on one or more frequencies in the CFL before attempting to reestablish an RRC connection on any of the last camped frequencies.

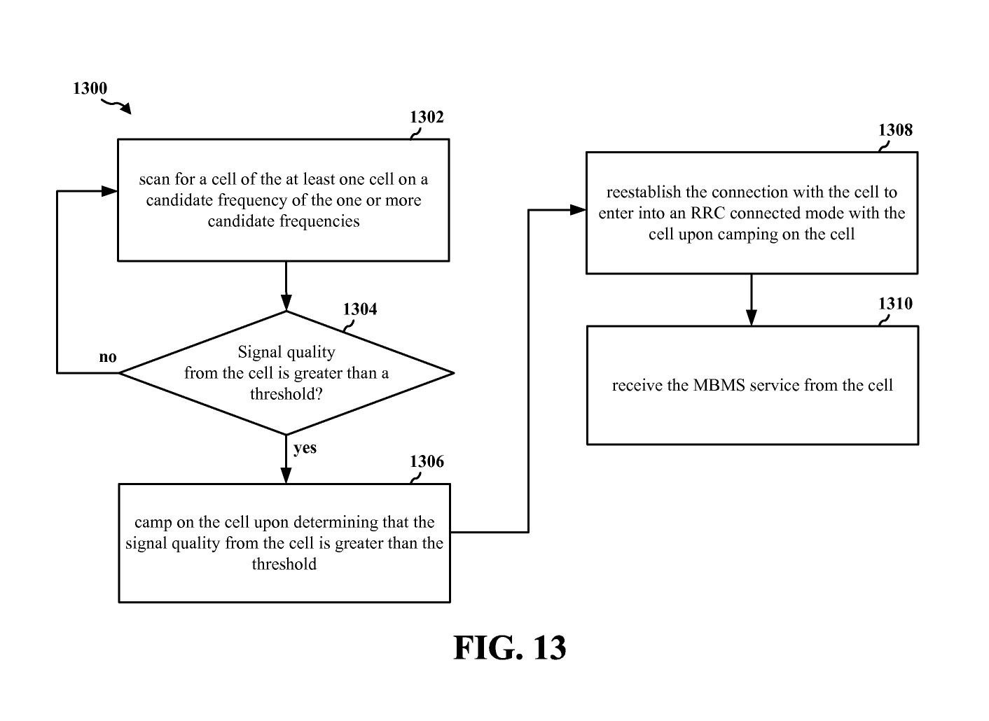

FIG. 13 is a flow chart 1300 of a second method of wireless communication. The method may be performed by a UE. The UE may be in an RRC connected mode with the serving cell, and may then determine that the UE encountered an RLF on the serving cell. In step 1302, the UE scans for a cell of the at least one cell on a candidate frequency of the one or more candidate frequencies. In step 1304, the UE determines whether the signal quality from the cell is greater than a threshold. If the signal quality is less than the threshold, the UE returns to step 1302, and scans for another cell of the at least one cell. If the signal quality is greater than the threshold, in step 1306, the UE camps on the cell. For example, assume the UE computes a CFL to include the frequencies f₂ and f₃. The UE may initially scan for the frequency f₂. If the signal quality is greater than a threshold, the UE may camp on the frequency f₂. If the signal quality is less than the threshold, the UE may then scan for the frequency f₃. In step 1308, the UE reestablishes the connection with the cell to enter into an RRC connected mode with the cell upon camping on the cell. The UE may reestablish the connection with the cell by performing a RACH procedure with the cell. In step 1310, the UE receives the MBMS service from the cell.

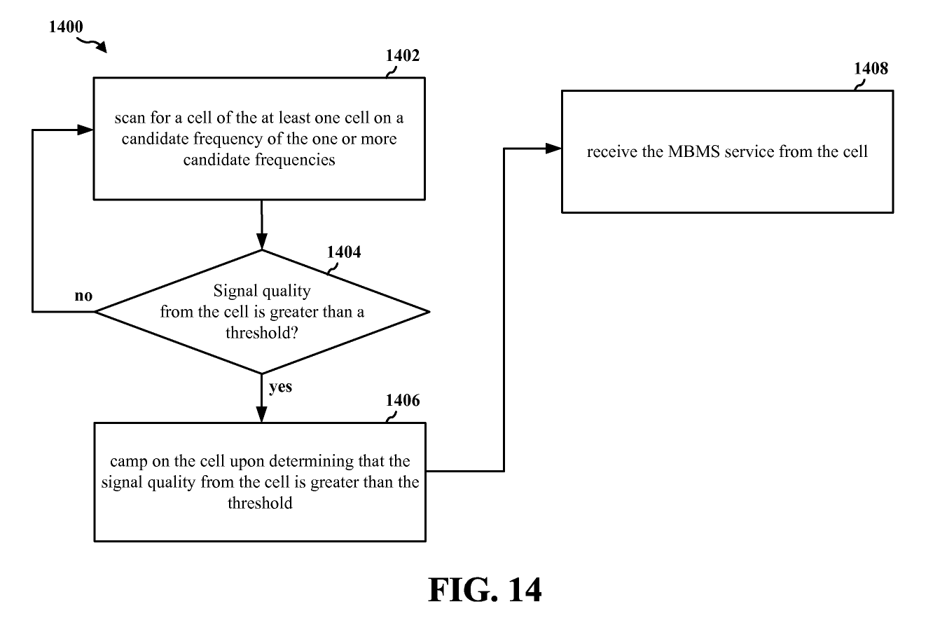

FIG. 14 is a flow chart 1400 of a third method of wireless communication. The method may be performed by a UE. The UE may be in an RRC idle mode with the serving cell, and may then determine that the UE encountered an OOS on the serving cell. In step 1402, the UE scans for a cell of the at least one cell on a candidate frequency of the one or more candidate frequencies. In step 1404, the UE determines whether the signal quality from the cell is greater than a threshold. If the signal quality is less than the threshold, the UE returns to step 1402, and scans for another cell of the at least one cell. If the signal quality is greater than the threshold, in step 1406, the UE camps on the cell. For example, assume the UE computes a CFL to include the frequencies f₂ and f₃. The UE may initially scan for the frequency f₂. If the signal quality is greater than a threshold, the UE may camp on the frequency f₂. If the signal quality is less than the threshold, the UE may then scan for the frequency f₃. In step 1408, the UE may receive the MBMS service from the cell.

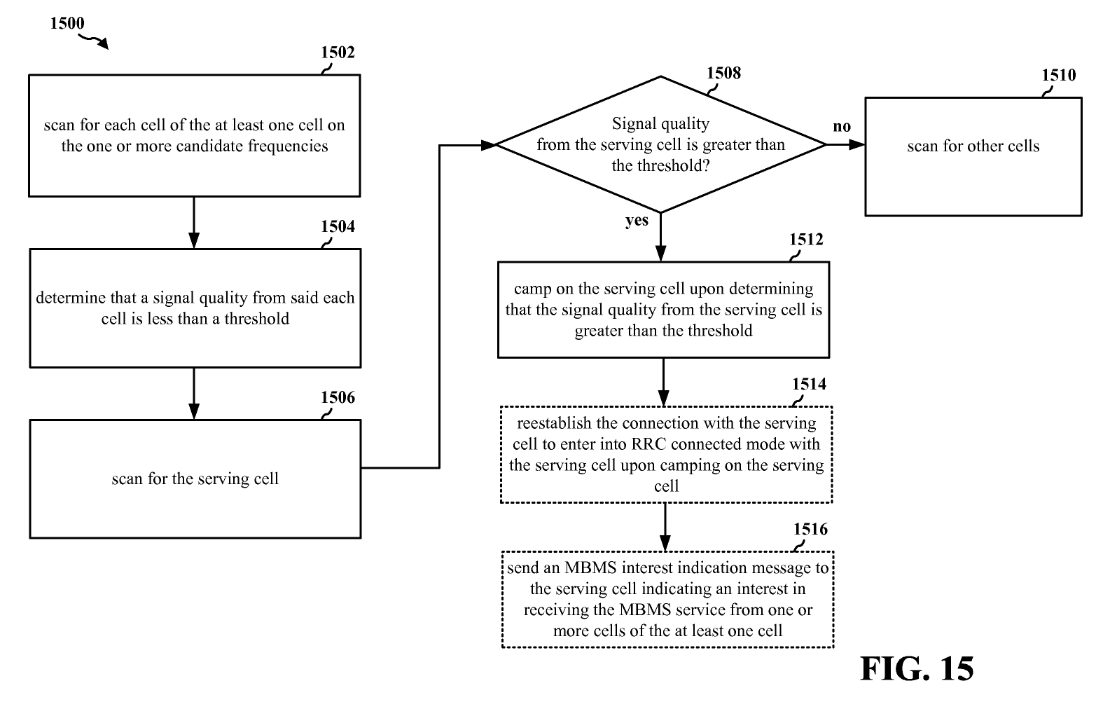

FIG. 15 is a flow chart 1500 of a fourth method of wireless communication. The method may be performed by a UE. In step 1502, the UE scans for each cell of the at least one cell on the one or more candidate frequencies. At step 1504, the UE determines that a signal quality from said each cell is less than a threshold. At step 1506, the UE scans for the serving cell (see FIG. 12 for the serving cell). At step 1508, the UE determines whether a signal quality from the serving cell is greater than the threshold. If the signal quality from the serving cell is less than the threshold, in step 1510, the UE scans for other cells. If the signal quality from the serving cell is greater than the threshold, in step 1512, the UE camps on the serving cell.

Before step 1502, the UE may have been in an RRC idle mode with the serving cell and determined that the UE encountered an OOS on the serving cell. Alternatively, before step 1502, the UE may have been in an RRC connected mode with the serving cell and determines that the UE encountered an RLF on the serving cell. If the UE encountered an RLF on the serving cell while in an RRC connected mode with the serving cell, in step 1514, the UE reestablishes the connection with the serving cell to enter into RRC connected mode with the serving cell upon camping on the serving cell. The UE may reestablish the connection with the serving cell by performing a RACH procedure with the serving cell. In step 1516, the UE sends an MBMS interest indication message to the serving cell indicating an interest in receiving the MBMS service from one or more cells of the at least one cell. The UE may subsequently receive a hand over to a cell of the one or more cells based on the MBMS interest indication message sent to the serving cell.

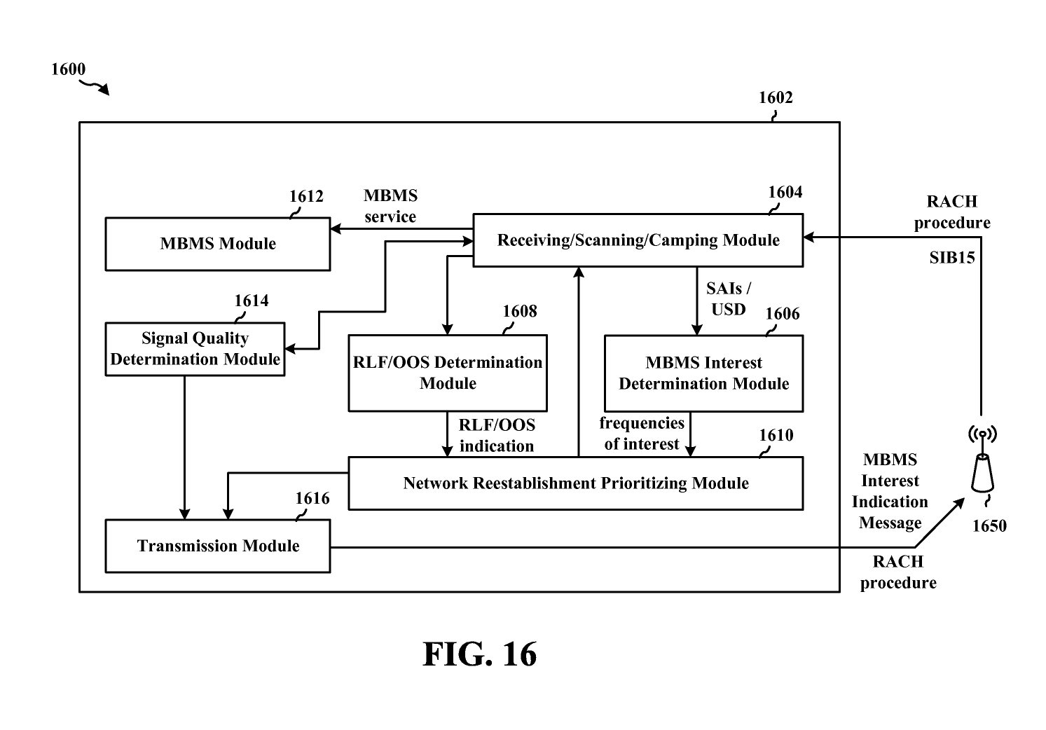

FIG. 16 is a conceptual data flow diagram 1600 illustrating the data flow between different modules/means/components in an exemplary apparatus 1602. The apparatus may be a UE. The apparatus includes a receiving/scanning/camping module 1604 that is configured to receive, from a serving cell, system information including a plurality of SAIs. The apparatus further includes an MBMS interest determination module 1606 that is configured to determine an interest in receiving an MBMS service from at least one cell on one or more candidate frequencies based on the received SAIs. The apparatus further includes an RLF/OOS determination module 1608 that is configured to determine that the UE has encountered one of an RLF or an OOS on the serving cell. The MBMS interest determination module 1606 may provide frequencies of interest to a network reestablishment prioritizing module 1610. The RLF/OOS determination module 1608 may inform the network reestablishment prioritizing module 1610 of the RLF/OOS. The network reestablishment prioritizing module 1610 is configured to prioritize network reestablishment on the one or more frequencies that carry the MBMS service the UE is interested in receiving upon determining the UE encountered the one of the RLF or the OOS. The receiving/scanning/camping module 1604 may be configured to camp on the serving cell prior to receiving the system information from the serving cell. The system information may be received in a SIB15. The receiving/scanning/camping module 1604 may be configured to scan for a cell of the at least one cell on a candidate frequency of the one or more candidate frequencies. The apparatus may include a signal quality determination module 1614 that is configured to determine whether the signal quality from the cell is greater than a threshold. The signal quality determination module 1614 may inform the receiving/scanning/camping module 1604 whether the receiving/scanning/camping module 1604 may camp on the cell. The receiving/scanning/camping module 1604 may be configured to camp on the cell upon the signal quality determination module 1614 determining that the signal quality from the cell is greater than the threshold.

The UE may determine that the UE encountered an RLF on the serving cell. The UE may have been in an RRC connected mode with the serving cell prior to encountering the RLF on the serving cell. The apparatus may include a transmission module 1615 that, together with the receiving/scanning/camping module 1604, is configured to reestablish the connection with the cell to enter into an RRC connected mode with the cell upon camping on the cell. The apparatus may include an MBMS module 1612 that is configured to receive the MBMS service from the cell. The UE may determine that the UE encountered an OOS on the serving cell. The UE may have been in an RRC idle mode with the serving cell prior to encountering the OOS on the serving cell. The MBMS module 1612 is configured to receive the MBMS service from the cell.

The receiving/scanning/camping module 1604 may be configured to scan for each cell of the at least one cell on the one or more candidate frequencies. The signal quality determination module 1614 may be configured to determine that a signal quality from said each cell is less than a threshold. The receiving/scanning/camping module 1604 may be configured to scan for the serving cell. The signal quality determination module 1614 may be configured to determine whether a signal quality from the serving cell is greater than the threshold. The receiving/scanning/camping module 1604 may be configured to camp on the serving cell upon determining that the signal quality from the serving cell is greater than the threshold. The UE may determine that the UE encountered an RLF on the serving cell. The UE may have been in an RRC connected mode with the serving cell prior to encountering the RLF on the serving cell. The transmission module 1616 and the receiving/scanning/camping module 1604 may be configured to reestablish the connection with the serving cell to enter into RRC connected mode with the serving cell upon camping on the serving cell. The transmission module 1616 may be configured to send an MBMS interest indication message to the serving cell indicating an interest in receiving the MBMS service from one or more cells of the at least one cell. The UE may determine that the UE encountered an OOS on the serving cell. The UE may have been in an RRC idle mode with the serving cell prior to encountering the OOS on the serving cell.

The apparatus may include additional modules that perform each of the steps of the algorithm in the aforementioned flow charts of FIGS. 12-15. As such, each step in the aforementioned flow charts of FIGS. 12-15 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

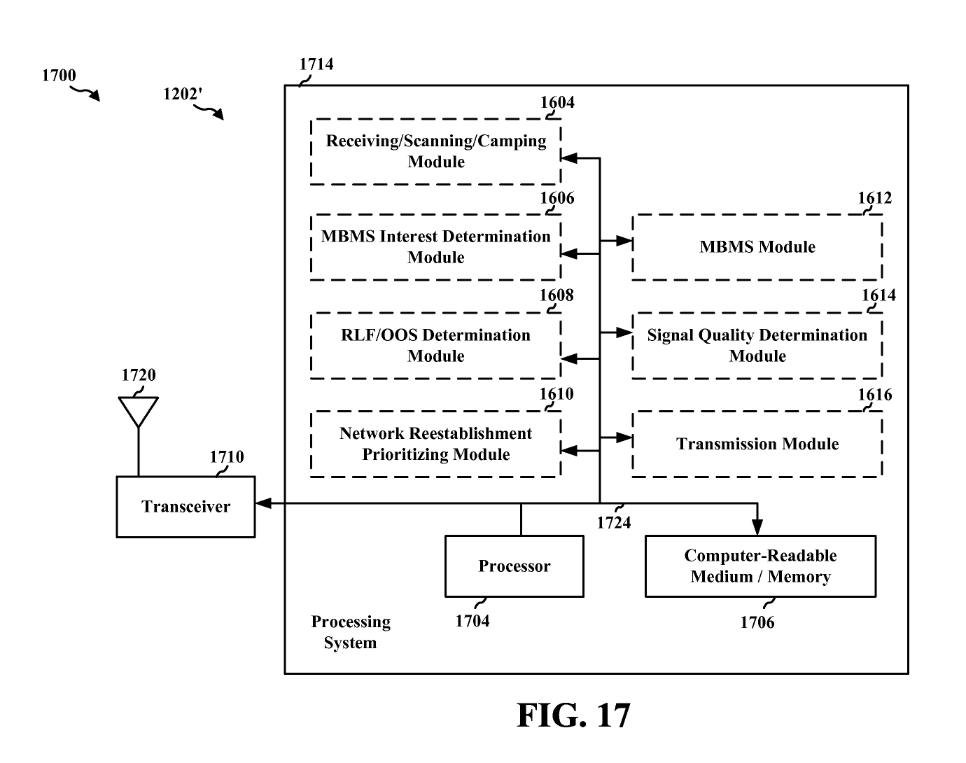

FIG. 17 is a diagram 1700 illustrating an example of a hardware implementation for an apparatus 1602′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware modules, represented by the processor 1704, the modules 1604, 1606, 1608, 1610, 1612, 1614, 1616, and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714. In addition, the transceiver 1710 receives information from the processing system 1714, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system further includes at least one of the modules 1604, 1606, 1608, 1610, 1612, 1614, and 1616. The modules may be software modules running in the processor 1704, resident/stored in the computer readable medium/memory 1706, one or more hardware modules coupled to the processor 1704, or some combination thereof. The processing system 1714 may be a component of the UE 650 and may include the memory 660 and/or at least one of the TX processor 668, the RX processor 656, and the controller/processor 659.

In one configuration, the apparatus 1602/1602′ for wireless communication includes means for receiving, from a serving cell, system information including a plurality of SAIs. The apparatus further includes means for determining an interest in receiving an MBMS service from at least one cell on one or more candidate frequencies based on the received SAIs. The apparatus further includes means for determining that the UE has encountered one of an RLF or an OOS on the serving cell. The apparatus further includes means for prioritizing network reestablishment on the one or more frequencies that carry the MBMS service the UE is interested in receiving upon determining the UE encountered the one of the RLF or the OOS.

The apparatus may further include means for camping on the serving cell prior to receiving the system information from the serving cell. The apparatus may further include means for scanning for a cell of the at least one cell on a candidate frequency of the one or more candidate frequencies, means for determining whether the signal quality from the cell is greater than a threshold, and means for camping on the cell upon determining that the signal quality from the cell is greater than the threshold. In one configuration, the UE determines that the UE encountered an RLF on the serving cell, the UE was in an RRC connected mode with the serving cell prior to encountering the RLF on the serving cell, and the apparatus further includes means for reestablishing the connection with the cell to enter into an RRC connected mode with the cell upon camping on the cell, and means for receiving the MBMS service from the cell. In one configuration, the UE determines that the UE encountered an OOS on the serving cell, the UE was in an RRC idle mode with the serving cell prior to encountering the OOS on the serving cell, and the apparatus further includes means for receiving the MBMS service from the cell. The apparatus may further include means for scanning for each cell of the at least one cell on the one or more candidate frequencies, means for determining that a signal quality from said each cell is less than a threshold, means for scanning for the serving cell, means for determining whether a signal quality from the serving cell is greater than the threshold, and means for camping on the serving cell upon determining that the signal quality from the serving cell is greater than the threshold. In one configuration, the UE determines that the UE encountered an RLF on the serving cell, the UE was in an RRC connected mode with the serving cell prior to encountering the RLF on the serving cell, and the apparatus further includes means for reestablishing the connection with the serving cell to enter into RRC connected mode with the serving cell upon camping on the serving cell, and means for sending an MBMS interest indication message to the serving cell indicating an interest in receiving the MBMS service from one or more cells of the at least one cell.

The aforementioned means may be one or more of the aforementioned modules of the apparatus 1602 and/or the processing system 1714 of the apparatus 1602′ configured to perform the functions recited by the aforementioned means. As described supra, the processing system 1714 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
receiving, from a serving cell, system information including a plurality of service area identities (SAIs);
determining an interest in receiving a Multimedia Broadcast Multicast Service (MBMS) service from at least one cell on one or more candidate frequencies based on the received SAIs;
determining that the UE has encountered one of a radio link failure (RLF) or an out of service (OOS) on the serving cell; and
prioritizing network reestablishment on the one or more frequencies that carry the MBMS service the UE is interested in receiving upon determining the UE encountered the one of the RLF or the OOS.

2. The method of claim 1, further comprising camping on the serving cell prior to receiving the system information from the serving cell.

3. The method of claim 1, wherein the system information is received in a system information block 15.

4. The method of claim 1, further comprising:
scanning for a cell of the at least one cell on a candidate frequency of the one or more candidate frequencies;
determining whether the signal quality from the cell is greater than a threshold; and
camping on the cell upon determining that the signal quality from the cell is greater than the threshold.

5. The method of claim 4, wherein the UE determines that the UE encountered an RLF on the serving cell, the UE was in a radio resource control (RRC) connected mode with the serving cell prior to encountering the RLF on the serving cell, and the method further comprises:
reestablishing the connection with the cell to enter into an RRC connected mode with the cell upon camping on the cell; and
receiving the MBMS service from the cell.

6. The method of claim 4, wherein the UE determines that the UE encountered an OOS on the serving cell, the UE was in a radio resource control (RRC) idle mode with the serving cell prior to encountering the OOS on the serving cell, and the method further comprises receiving the MBMS service from the cell.

7. The method of claim 1, further comprising:
scanning for each cell of the at least one cell on the one or more candidate frequencies;
determining that a signal quality from said each cell is less than a threshold;
scanning for the serving cell;
determining whether a signal quality from the serving cell is greater than the threshold; and
camping on the serving cell upon determining that the signal quality from the serving cell is greater than the threshold.

8. The method of claim 7, wherein the UE determines that the UE encountered an RLF on the serving cell, the UE was in a radio resource control (RRC) connected mode with the serving cell prior to encountering the RLF on the serving cell, and the method further comprises:
reestablishing the connection with the serving cell to enter into RRC connected mode with the serving cell upon camping on the serving cell; and
sending an MBMS interest indication message to the serving cell indicating an interest in receiving the MBMS service from one or more cells of the at least one cell.

9. The method of claim 7, wherein the UE determines that the UE encountered an OOS on the serving cell, and the UE was in a radio resource control (RRC) idle mode with the serving cell prior to encountering the OOS on the serving cell.

10. An apparatus for wireless communication, the apparatus being a user equipment (UE), comprising:
means for receiving, from a serving cell, system information including a plurality of service area identities (SAIs);
means for determining an interest in receiving a Multimedia Broadcast Multicast Service (MBMS) service from at least one cell on one or more candidate frequencies based on the received SAIs;
means for determining that the UE has encountered one of a radio link failure (RLF) or an out of service (OOS) on the serving cell; and
means for prioritizing network reestablishment on the one or more frequencies that carry the MBMS service the UE is interested in receiving upon determining the UE encountered the one of the RLF or the OOS.

11. The apparatus of claim 10, further comprising means for camping on the serving cell prior to receiving the system information from the serving cell.

12. The apparatus of claim 10, wherein the system information is received in a system information block 15.

13. The apparatus of claim 10, further comprising:
means for scanning for a cell of the at least one cell on a candidate frequency of the one or more candidate frequencies;
means for determining whether the signal quality from the cell is greater than a threshold; and
means for camping on the cell upon determining that the signal quality from the cell is greater than the threshold.

14. The apparatus of claim 13, wherein the UE determines that the UE encountered an RLF on the serving cell, the UE was in a radio resource control (RRC) connected mode with the serving cell prior to encountering the RLF on the serving cell, and the apparatus further comprises:
means for reestablishing the connection with the cell to enter into an RRC connected mode with the cell upon camping on the cell; and
means for receiving the MBMS service from the cell.

15. The apparatus of claim 13, wherein the UE determines that the UE encountered an OOS on the serving cell, the UE was in a radio resource control (RRC) idle mode with the serving cell prior to encountering the OOS on the serving cell, and the apparatus further comprises means for receiving the MBMS service from the cell.

16. The apparatus of claim 10, further comprising:
means for scanning for each cell of the at least one cell on the one or more candidate frequencies;
means for determining that a signal quality from said each cell is less than a threshold;
means for scanning for the serving cell;
means for determining whether a signal quality from the serving cell is greater than the threshold; and
means for camping on the serving cell upon determining that the signal quality from the serving cell is greater than the threshold.

17. The apparatus of claim 16, wherein the UE determines that the UE encountered an RLF on the serving cell, the UE was in a radio resource control (RRC) connected mode with the serving cell prior to encountering the RLF on the serving cell, and the apparatus further comprises:
means for reestablishing the connection with the serving cell to enter into RRC connected mode with the serving cell upon camping on the serving cell; and
means for sending an MBMS interest indication message to the serving cell indicating an interest in receiving the MBMS service from one or more cells of the at least one cell.

18. The apparatus of claim 16, wherein the UE determines that the UE encountered an OOS on the serving cell, and the UE was in a radio resource control (RRC) idle mode with the serving cell prior to encountering the OOS on the serving cell.

19. A computer program product in a user equipment (UE), comprising:
a computer-readable medium comprising code for:
receiving, from a serving cell, system information including a plurality of service area identities (SAIs);
determining an interest in receiving a Multimedia Broadcast Multicast Service (MBMS) service from at least one cell on one or more candidate frequencies based on the received SAIs;
determining that the UE has encountered one of a radio link failure (RLF) or an out of service (OOS) on the serving cell; and
prioritizing network reestablishment on the one or more frequencies that carry the MBMS service the UE is interested in receiving upon determining the UE encountered the one of the RLF or the OOS.

20. The computer program product of claim 19, wherein the computer-readable medium further comprises code for camping on the serving cell prior to receiving the system information from the serving cell.
